(19) United States
(12) Patent Application Publication
(10) Pub. No.: US 2018/0268050 A1
(43) Pub. Date: Sep. 20, 2018

(54) METHOD AND SYSTEM FOR TIME SERIES VISUAL ANALYSIS AND PATTERN SEARCH

(71) Applicants: Radoslav Paraschkavov Kotorov, Somerset, NJ (US); Dave Watson, Ingatestone (GB)

(72) Inventors: Radoslav Paraschkavov Kotorov, Somerset, NJ (US); Dave Watson, Ingatestone (GB)

(73) Assignee: Trendalyze Inc., Newark, NJ (US)

(21) Appl. No.: 15/917,061

(22) Filed: Mar. 9, 2018

Related U.S. Application Data
(60) Provisional application No. 62/473,349, filed on Mar. 18, 2017.

(51) Int. Cl. G06F 17/30

(52) U.S. Cl. CPC G06F 17/30604; G06F 3/0482; G06F 17/30551; G06F 17/30554

(57) ABSTRACT

A method and system providing the ability to visually explore temporal data, to identify and tag patterns, and to conduct proximity searches for similar patterns across different data sets, dimensions and/or hierarchical levels. Time series patterns manifest themselves at different levels of aggregation. In one embodiment of the invention, the proximity search parameters are derived from an aggregate level trend and are algorithmically adjusted to find matching patterns within detailed records. Further, the method includes means to traverse time series data, to select subsets of time sequences, and to evaluate statistically the said subsets for proximity to the original time sequence. The method and system provide means to connect and browse temporal data in databases, applications, files, and real-time data streams, to monitor for time-series patterns, and to generate event based alerts. It further includes a metadata based knowledge repository for time series patterns and means for collaborative time-series analysis.

### CLAIM OF PRIORITY

This application is claims priority to U.S. Provisional Patent Application No. 62/473,349, filed Mar. 18, 2017 and herein incorporated by reference in its entirety.

### FIELD OF THE EMBODIMENTS

The present invention relates to the field of interactively querying data and more specifically to the field of time-series motifs discovery and search.

### BACKGROUND OF THE EMBODIMENTS

Discovering re-occurring time patterns, called motifs, in time-series data is very beneficial as it enabled hidden and difficult to discern relationships to be uncovered that can facilitate drug discovery and disease treatment in healthcare, eliminate failures and inefficiencies in industrial and manufacturing processes, track usage patterns in retail, energy consumption, and other industries to optimize services and resource utilization, fraud and abuse prevention in financial transactions, early detection of security breaches, among other functions. Once motifs are discovered and understood, they can be used in monitoring applications that can scale to millions of users.

The benefits of time series pattern analysis have been known for a long time. Various statistical methods, such as seasonality analysis, have been developed to discover repeating patterns. However, those methods work on systematically repeating patterns. For example, sales patterns are consistently determined by holidays. Motifs, on the other hand, can occur at irregular intervals, which makes them hard to detect.

The emergence of the Internet of Things (IoT) allows for the collection of big time series data sets because embedded sensors can collect and transmit biometrics and machine generated data at very small intervals. These very big data sets hold the biggest promise for scientific discovery and optimization and the present invention provides a method and a system that solves the problem of fending motifs in such large data sets.

### SUMMARY OF THE EMBODIMENTS

In accordance with the embodiments described herein, a method and a system is disclosed for motif discovery, search and monitoring in time-series data sets and data streams. This summary is not an extensive overview, and it is not intended to identify key/critical elements or delineate the scope thereof. Its sole purpose is to present some concepts in a simplified for in as a prelude to more detailed description that is presented late.

The method and system provides means for ingesting and storing data sets and data streams in a file-based storage structure, for creating of a unifying virtual logical structure for all stored data sets and a common metadata, for visualization of the time-series at various levels of granularity, a GUI interface for interaction with the time-series data and for selection of distinct time sequences of interest, a search method and algorithms for discovering similar time sequences called motifs within and across the stored or streamed data sets, and an automation of the searching for motifs for monitoring and alerting purposes.

Time-series data can be collected from multiple devices, databases and systems. Each device and system can store or stream the time-series data in a different file format with a different file structure and physical metadata descriptions about the contents in the file. Such diverse individual files are ingested into the motif discovery file-based storage structure. A unifying logical metadata layer allows to create a single virtual metadata file for all individual data files stored in the backend and to present it to the end user as a simplified view of the data for analysis, visualization and searching for motifs. The logical metadata is used to define the GUI presentation of the data, the permissible interactions with the GUI controls and visualizations, the query generation, and the motif searching.

Users explore the time-series data sets by using GUI controls and the logical n metadata objects presented in those controls to define what data is displayed, to perform aggregations, to apply filters or calculations, and to perform other operations. The logical metadata objects used by the users define the parameters of the query to be generated against the file-based storage backend and the display of the returned data by the query.

Motif search is performed by storing the user selected time sequence in an array. The array is used to generate a memory structure or file of all possible sequences which are then compared against the original data. The comparisons are statistically evaluated for proximity to the original selection, and the results are rank ordered. Various statistical methods for evaluation can be applied. The discovered motifs are returned and displayed on visualizations controls by the front-end. Users can perform various comparative interactions in order to understand the motifs significance.

Motifs of interest can be stored and used as search parameters for automatic monitoring within newly ingested data. Users can subscribe to be alerted upon detection of the occurrence of particular motifs.

Users can define predictive alerting based on the frequency of occurrence of motifs.

### BRIEF DESCRIPTION OF THE DRAWINGS

FIG. 1 shows an ingestion of data files in a file-based backend storage, according to an embodiment of the present invention.

FIG. 2 shows files having different formats and physical metadata, according to an embodiment of the present invention.

FIG. 3 shows the mapping of file attributes to the unifying virtual mapping grid, according to an embodiment of the present invention.

FIG. 4A shows the creation of metadata for columns in the unifying virtual mapping grid, according to an embodiment of the present invention.

FIG. 4B shows the creation of virtual calculation objects based on the unifying virtual mapping grid, according to an embodiment of the present invention.

FIG. 4c shows the creation of virtual hierarchies based on the unifying virtual mapping grid, according to an embodiment of the present invention.

FIG. 5A illustrates the query generation based on the unifying virtual mapping grid, according to an embodiment of the present invention.

FIG. 5B illustrates the metadata driven rules for controlling the GUI display and interactions, according to an embodiment of the present invention.

FIG. 6A illustrates a method for motif search, according to an embodiment of the present invention.

FIG. 6B shoes a display of the matched motifs on a visualization control, according to an embodiment of the present invention.

FIG. 7 shows an architectural view of the components of the system, according to an embodiment of the present invention.

### DESCRIPTION OF THE PREFERRED EMBODIMENTS

Various embodiments of the present invention will be described in detail with the reference to the drawings. Where like reference numerals represent like parts and assemblies throughout the several views.

References to various embodiments do not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

Referring, now to FIG. 1, ingestion and storage of time-series data files from file repositories 101, applications 102, and personal devices 103 into the scalable file-based backend data storage 100 are illustratively depicted, in accordance with an embodiment of the present invention.

104 shows the physical structure of File 1 which is defined by the number and arrangement of columns in the file. 105 shows a dimension column, D1, in File 1. Dimensions are special columns in which values can be used to group the data into categories. For example, “Country” is a dimension that enables grouping and summarizing the data for each country. 106. shows a time column that stores the time at which each measurement is taken. 107 shows the column for storing measurements such as machine gauge values or biometric healthcare readings.

According to an embodiment, every column in a data file is classified for the proposes of the present invention as a dimension, time, or measure. According to an embodiment, the original data files may have the same number and types of columns, but the order of the columns within the files may be different, as it is for File 1 and File 2. According to an embodiment, some files may have a different number of columns, as, for example, File 1 File 3, and File 4. These files have some common columns as, for example, all three files have columns D1, T1, and M1. Compared to File 1, File 4 has two additional columns, T2 and M3, but does not contain column M2. Such a diverse collection of files cannot be analyzed easily and in a uniform way without imposing a unifying structure.

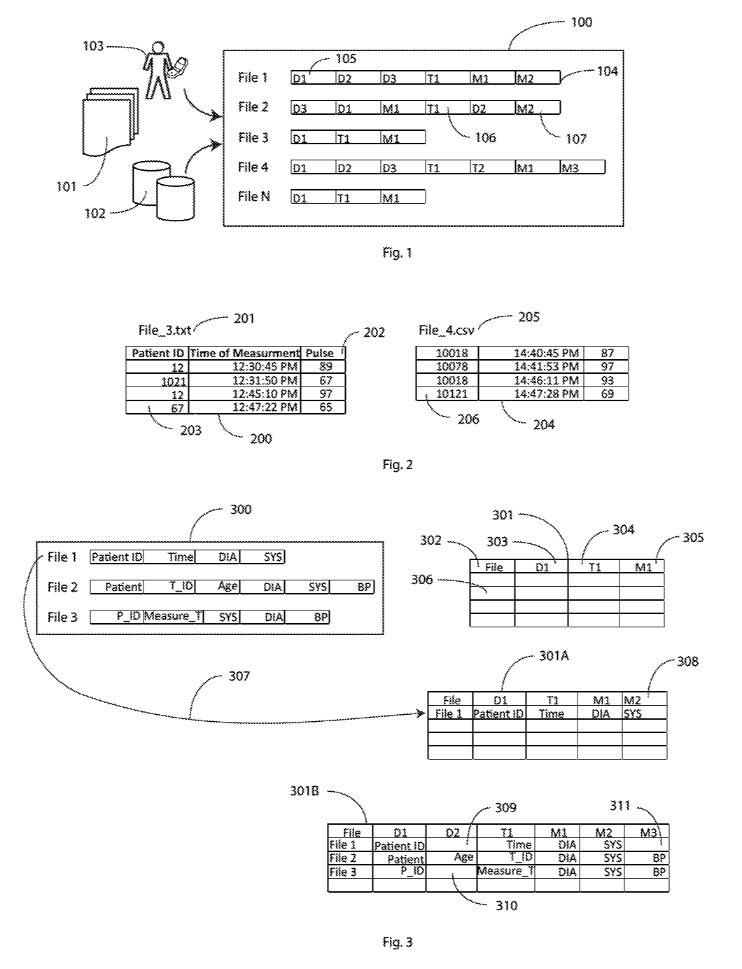

Referring now to FIG. 2, two data files 200 and 204 having different formats and different physical metadata are illustratively depicted, in accordance with an embodiment of the present invention.

201 shows the file name and the file format extension of file 200. 205 shows the file name and the file format extension of file 204. According to an embodiment, file 200 is a “txt” file format while file 204 is a “csv” file format. For those skillful in the art it will be immediately obvious that the present invention can ingest and store data from many different formats and sources. It is therefore noted that any suitable format may be used while maintaining the spirit of the present invention.

203 and 206 show individual records stored in rows within tiles 200 and 204. 202 shows the file header for file 200 which defines the column titles and the physical metadata describing the data in each column. File 204 does not have such a header and does not contain physical metadata describing the data in each column. According to an embodiment a unifying logical metadata has to be created in order for users to be able to analyze the two data files together.

Referring now to FIG. 3, the mapping of data files stored in the file based backend storage 300 to the unifying virtual mapping grid 301 is illustratively depicted, in accordance with an embodiment of the present invention.

According to an embodiment, the unifying virtual mapping grid 301 has a logical structure of a flat file containing a file identification column 302, and columns 303, 304, 305 for mapping dimensions, time, and measures.

306 shows an empty row in the unifying virtual mapping grid 301. Each file stored in the backend 300 is mapped to a row in the mapping and 301. 307 shows the mapped structure of File 1 to the virtual mapping grid 301A. 308 shows an additional measure column being added to the mapping grid 301A for the extra column contained in File 1.

According to an embodiment, users may add as many dimension, time and measure columns to the unifying virtual mapping grid as it is needed to map all the columns from the physical files. 301B shows the mapping of all files from backend 300 to the unifying virtual mapping grid, thus creating a single logical structure to be used by end-users for analysis, visualization, and in the search for motifs. The single logical structure makes it immediately evident that File 1 and File 3 do not have dimension D2 as shown by 309 and 310.

311 shows that File 1 also does not contain M3. Knowing which files have common columns enables fully conforming subsets of data to be created at the point of querying the data, i.e., subsets of data sharing the same number of dimensions, time and measures. Knowing the conformity is important in order to generate the correct query to return accurate aggregate calculations.

Referring now to FIG. 4A, the creation of metadata for the unifying virtual mapping grid 400 is illustratively depicted, in accordance with an embodiment of the present invention.

According to an embodiment, by clicking on a column 401, the user invokes a dialog 402 and an input box 403 to create a new metadata title for a particular column. In this example, the user types a new title “PULSE” to replace the delimit column title “M3”. The new metadata column titles are used as display values in the GUI, in the visual controls, tables, and all other controls and outputs produced by the system. For those skillful in the art it will be immediately obvious that different UIs and methods are possible to set the new metadata values.

Referring now to FIG. 4B, the creation of another virtual object in the unifying mapping grid by the end users is illustratively depicted, in accordance with an embodiment of the present invention.

404 is a new virtual calculation column, i.e., a column which values do not exist in the physical data sets and are calculated and presented to the end users at run time, i.e., when they actually run query. 405 shows the creation of a title for the new column. 406 shows the creation of the calculation for the new column. In this case, the computed value is created by subtracting the values of two physical columns: DIA minus SYS. For those skillful in the art, it will be immediately obvious that various types of virtual columns can be created, such as columns having constant values, columns grouping data in different ways, columns cleansing and standardizing the data of other columns, etc.

Referring now to FIG. 4C, the creation of another type of metadata object, a hierarchy, is illustratively depicted, in accordance with and embodiment of the present invention.

According to an embodiment, columns 407, 408 and 409 have a natural order in the real world as they represent countries, states within countries, and cities within states. But this relationship is not defined in the physical data nor in the virtual mapping grid. Hence, according to an embodiment, the user defines the logical relationship and order in 410A, 410B and 410C.

According to an embodiment, the newly defined logical relationship and order is used in the GUI and by the query generating engine to define navigation paths for the end user, i.e., a user can navigate the data from country to state to city. For those skillful in the art, it will be immediately obvious that other metadata objects for data navigation can be defined in the metadata.

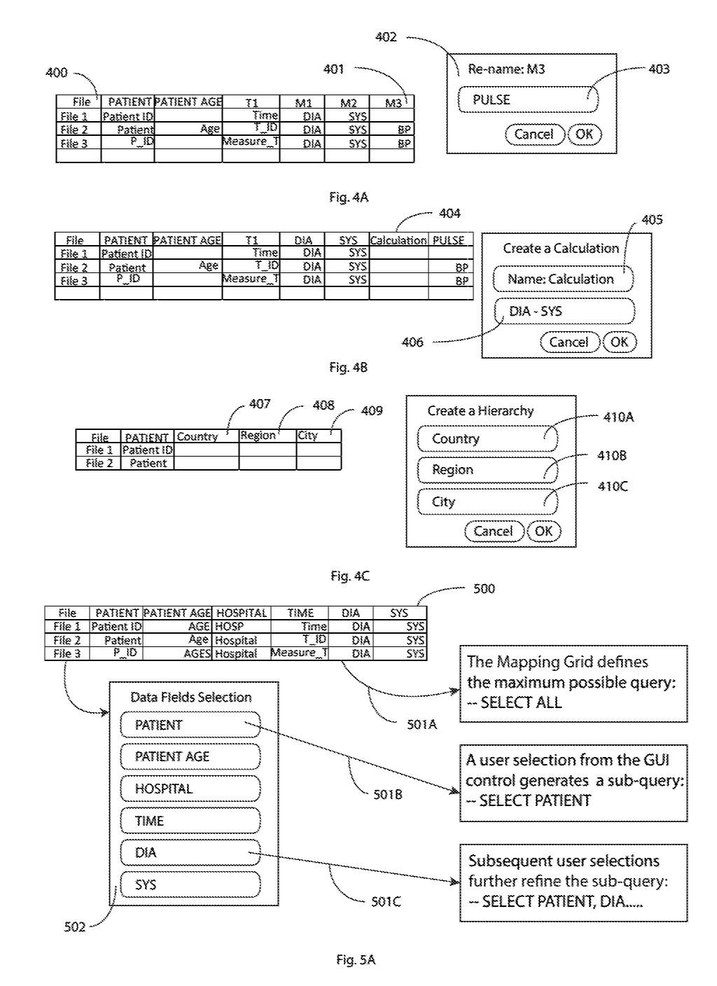

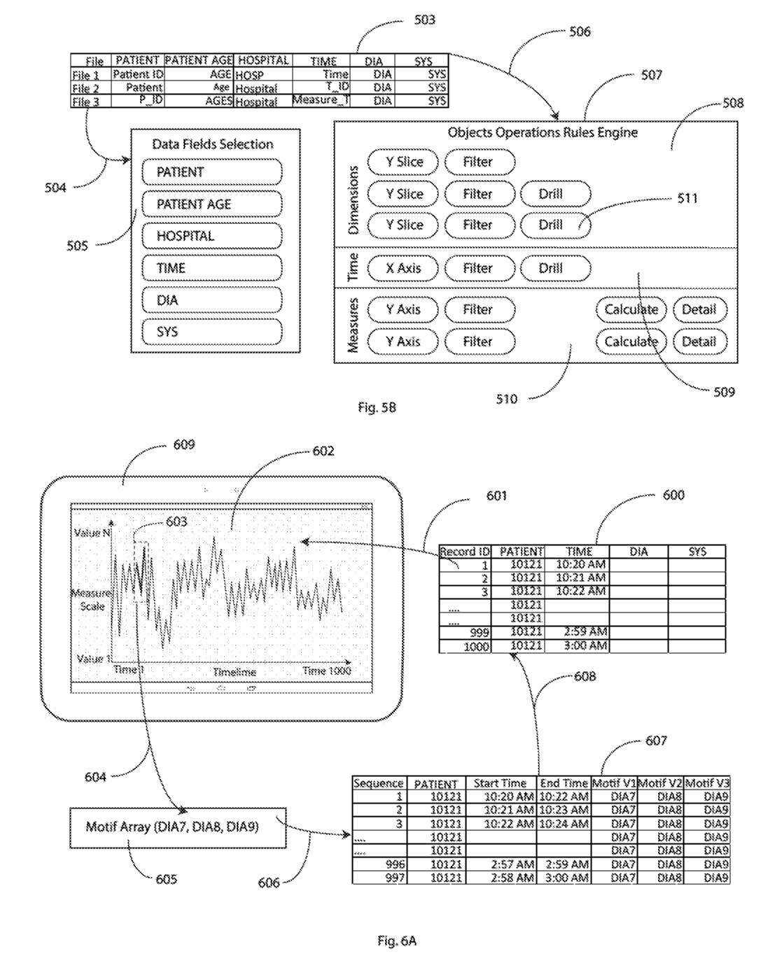

Referring now to FIG. 5A, how the unifying virtual mapping grid is used to define and instantiate parametrized query generation against the backend is illustratively depicted, in accordance with an embodiment of the present invention.

According to an embodiment, the columns in the mapping grid 500 define the maximum possible query against the backend. This is the query that selects all columns in 501A. The columns from the virtual mapping grid 500 are displayed on a GUI control 502. 501B shows the instantiation of parameters in the query.

According to an embodiment, when a user selects PATIENT from the GUI control 502, the field PATIENT is being added to the select clause of the query. 501B shows the addition of another field “DIA” to the select clause of the query. According to an embodiment, the instantiation of parameters in the query narrows down the definition of the results that will be returned by the query.

Referring now to FIG. 5B how the unifying virtual mapping grid and the logical metadata associated with it are used to control the display of data and the permissible user interactions with each metadata object in the GUI front-end is illustratively depicted, in accordance with an embodiment of the present invention.

According to an embodiment, the columns from the unifying virtual mapping grid 503 are mapped using a communication layer process 504 to a GUI control 505. Each metadata object in the unifying virtual mapping grid is mapped using a communication layer process 506 to a rules engine 507. The rules engine 507 recognizes distinct types of metadata objects such as dimensions 508, time 509 and measures 510, and associates distinct rules with each object type. For example, according to an embodiment, rule 511 allows a user to drill on dimension and time objects but not on measures. For those skillful in the art it will be immediately obvious that other types of metadata objects can be created with corresponding rules.

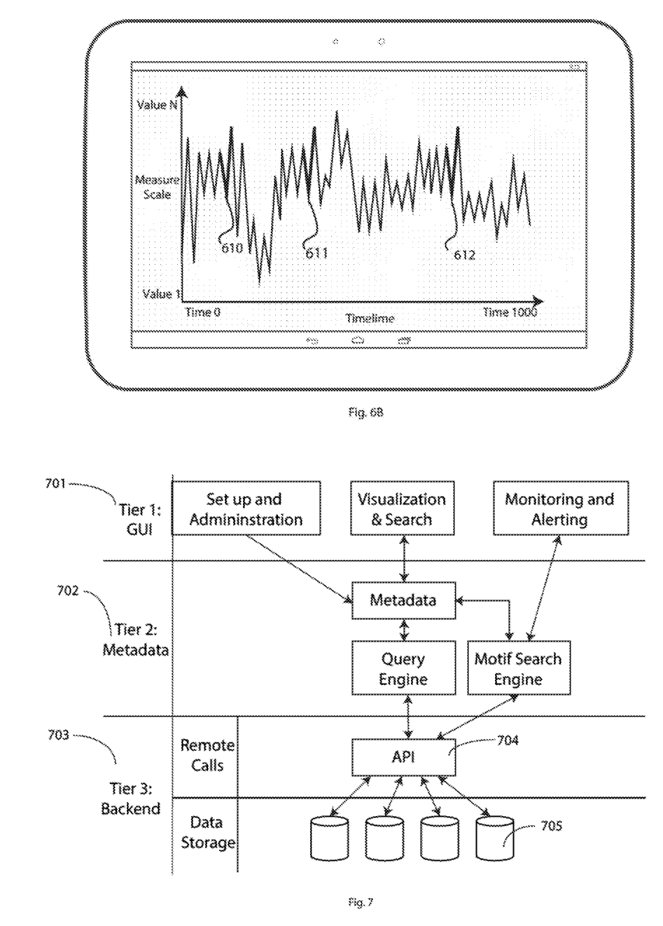

Referring, now to FIG. 6A, the motif search method is illustratively depicted, in accordance with an embodiment of the present invention.

According to an embodiment, the measurements for a particular patient are stored in a tabular file 600. There are 1000 measurements in file 600 as shown by the sequence number in column “Record ID”. The time series data is retrieved from file 600 via a query process 601 and displayed on a visual component 602 on a computer device 609. A user selects a time sequence 603 using standard mouse or gesture based selection methods. For those skillful in the art, it will be immediately obvious that a selection can also be made via a computer, program, process or API. A process 604 transforms the user time sequence selection 603 into an array 605 that is stored on the backend or in memory.

According to an embodiment, the array 605 contains all individual measurements for each of the selected time points within the time sequence. A process 606 creates a file 607 that contains all possible sequences and associates the values of the array 605 with each possible sequence. Since the user selected time sequence in this example has three time points, the number of all possible sequences is 1000−3=997 as shown in column “Sequence” in file 607. The contents of file 607 are matched vie a search process 608 against the original data file 600 to identify similar sequences. According to an embodiment, each possible sequence is statistically evaluated for similarity and is assigned a proximity score.

Referring now to FIG. 6B, the display of the original sequence 610 and the closely matching motifs, 611 and 612, is illustratively depicted, in accordance with an embodiment of the present invention.

According to an embodiment, the selected sequence and the discovered motifs are visually emphasized on the graph. Searches can be performed within a single time series, as shown here, or across multiple time-series, as for example, when the graph displays the time series for more than one patient. In addition, searches can be performed for multiple measures.

Referring now to FIG. 7, the architecture, the components, and the data flow within the system are illustratively depicted, in accordance with an embodiment of the present invention.

According to an embodiment, the architecture includes three tiers. The front-end GUI tier 701 has an administrative UI for setting pp the data upload, the metadata and the user administration; an analysis, visualization and search UI for users to interact with the data and perform motif searches; and a UI for monitoring and alerting when motifs occur in new data sets. The metadata tier 702 includes a metadata set up module which operations are described in detail in FIGS. 3, 4A, 4B and 4C; a query generation and execution engine which operations are described in detail in FIG. 5A; and a motif search engine which operations are described in detail in FIG. 6A and 6B. The backend tier 703 comprises of an API module 704 which translates the queries generated by the query engine into database 705 execution commands, and also allows for integration with other external applications and processes.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but riot limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s) gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and intemperate with one another.

The present invention may be based on computer systems that may comprise, but are not limited to, components such as: a computer systemization connected to memory.

### Computer Systemization

A computer systemization may comprise a clock, central processing unit (“CPU(s)” and/or “processor(s)” (these terms. are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n. Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptogaphic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus Peripheral Component Interconnect (Extended) (PCI(X)). PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced. Technology Attachment (Packet Tnterface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN), an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces ((I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio, video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a1b/g/n/x, Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and or the like. One typical output device may include a video display, which typically comprises a. Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g. an RCA composite video connector accepting an RCA composite video cable a DVI connector accepting a DVI display cable, etc.).

User input devices often are a type of peripheral device (see below) and may include: card readers, dongles, finger print readers, gloves, graphics tablets, joysticks, keyboards, microphones mouse (mice), remote controls, retina readers touch screens (e.g., capacitive, resistive, etc.), trackballs, trackpads sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g. still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc. may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz. Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly hull tolerant, scalable, and secure system such as: Apple Macintosh OS X (Server); AT&T Plan 9; Be OS Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP), HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126./myInformation.html might have the IP portion of the request “123.124.125.126” resolved by a DNS server to an information server at that IP address; that information server might in turn further parse the http request for the “/mayInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along, with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTMT FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater)encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, ands or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain communicate, generate, obtain, and/or provide program component system, user and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptogaphic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic. techniques such as, but not limited to: digital certificates X.509 authentication framework), digital signatures, dual signatures, enveloping password access protection, public key management, and/or the like. The cryptographic component will facilitate numerous (encryption and/or decryption) security protocols such as, but not limited to: checksum Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for time-series motifs search and visualization, comprising:
ingesting time-series data files in a file-based backend data storage;
instantiating a unifying virtual mapping grid to define a logical structure: for a domain of the time-series data files;
mapping the physical structures of the time-series data files to the logical structure for the domain of the time-series data files;
creating metadata for the unifying virtual mapping grid;
creating one or more virtual objects based on the unifying virtual mapping grid;
creating one or more virtual relationships between the virtual objects on the unifying mapping grid;
generating one or more rules for data presentation and user interactions with a graphical user interface based on the metadata of the unifying virtual mapping grid;
generating one or more dynamically metadata-driven parametrized queries from the user interactions with the graphical user interface;
selecting time-sequences on the graphical user interface, wherein the time-sequences are configured to act as search parameters to discover matching motifs; and
displaying one or more query and search results on the graphical user interface.

2. The method as recited in claim 1, wherein the logical structure of the unifying virtual mapping grid is a flat file structure.

3. The method as recited in claim 1, wherein the time-series data files include one or more physical columns, and
wherein the physical columns of the time-series data files are mapped to virtual columns. in the unifying virtual mapping grid.

4. The method as recited in claim 1, wherein the metadata for the unifying virtual mapping grid describes the contents and data types of each virtual column.

5. The method as recited in claim 1, wherein the one or more virtual objects are derived via one or more calculations from other virtual objects in the unifying virtual mapping grid.

6. The method as recited in claim 1, wherein the one or more virtual relationships between virtual objects include a hierarchy.

7. The method as recited in claim 1, wherein the one or more virtual relationships between virtual objects include one or more data navigation paths.

8. The method as recited in claim 1, wherein the unifying virtual mapping grid defines maximum possible query against the domain of the time-series data files.

9. The method as recited in claim 8, wherein the maximum possible query is winnowed down by passing metadata objects as parameters.

10. The method as recited in claim 1, wherein the selected time sequence for motif search is stored as an array for evaluating any possible matches.

11. The method as recited in claim 1, wherein the motif search generates a tile of all possible sequences and evaluates them against the time-series data files.

12. The method as recited in claim wherein the matching motifs are visually emphasized in the graphical user interface.

13. The method as recited in claim 1, wherein a prediction is generated for an occurrence of a motif.

14. The method as recited in claim 1, wherein an alert is generated for an occurrence of a motif.

15. A computer based system for time-series motifs search and visualization, comprising:
a file-based backend data storage optimized for large volumes of data files;
a data services interface module configured to provide data connection and data ingestion into the file-based backend data storage from external data sources;
a logical metadata layer configured to smite querying and motif searching within a set of domain specific time-series data files;
a query generation engine configured to receive metadata driven parameters to winnow down an executable query;
a motif search engine configured to generate all possible time-sequences and to evaluate their proximity to a user-selected time-sequence;
a metadata driven graphical user interface configured to display data for user exploration; and
a communication layer protocol configured to pass rules and data between the metadata layer, the graphical user interface, and the query and search engines.

16. The computer based system as recited in claim 15, wherein data is continuously streamed from one or more internet connected devices.

17. The computer based system as recited in claim 15, wherein the motif search engine is further configured to monitor for any occurrences of motif and to generate one or more alerts.

18. The computer based system as recited in claim 15, wherein the motif search engine generates one or more predictions about a likelihood of an occurrence of motifs.

19. A computer program product embodied in non-transitory computer-readable media carrying executable code, which code when executed:
produces a representation of a structure of physical data files stored in a file-based backend data storage;
produces a unifying virtual flat-file for querying and searching for motif within the physical data files stored in the file-based backend data storage;
generates an interactive graphical user interface to display virtual objects from the unifying virtual flat-file for query and search generation; and
generates visualizations of one or more queries and search results.

20. The computer program product as recited in claim 19, wherein the code, when executed, generates one or more predictions and alerts for an occurrence of time motifs.
